(19) United States
(12) Patent Application Publication
(10) Pub. No.: US 2013/0008265 A1
(43) Pub. Date: Jan. 10, 2013

(54) FORCE-MEASURING TRANSDUCER USING AN ELECTROMAGNETIC INDUCTION PHENOMENON

(76) Inventor: Heungjoon Park, Yongin (KR)

(21) Appl. No.: 13/519,960

(22) PCT Filed: Jun. 9, 2010
(86) PCT No.: PCT/KR10/03700

§ 371 Date: Sep. 24, 2012

(30) Foreign Application Priority Data
Dec. 31, 2009 (KR) 10-2009-0136165

(51) Int. Cl. G01L 1/04; G01L 1/14

(52) U.S. Cl. 73/862.626; 73/862.625

(57) ABSTRACT

The present invention relates to a force-measuring transducer which measures forces applied to or generated by a surface of a resiliently deformable structure. Forces applied to or generated by a surface of a structure may be surface forces generated by molecules at the surface of the structure, mechanical forces/pressure generated by placing the structure between objects, forces generated by materials which constitute the structure and which have different coefficients of thermal expansion, attractive/repulsive forces among atoms, or forces generated on a treated surface by ultraviolet (infrared) rays or the like. The transducer is characterized in that it measures forces applied to or generated by the surface of the structure using electrical signals generated in accordance with variations in electromagnetic fields.

### CROSS-REFERENCES TO RELATED APPLICATIONS

This application is a U.S. national phase application, pursuant to 35 U.S.C. §371, of PCT/KR2010/003700, filed Jun. 9, 2010, designating the United States, which claims priority to Korean Application No. 10-2009-0136165, filed Dec. 31, 2009. The entire contents of the aforementioned patent applications are incorporated herein by this reference.

### TECHNICAL FIELD

The present invention relates to a force measuring transducer for measuring a force applied to or generated on a surface of an elastically deformable structure. Generally, the force applied to or generated on a surface of a structure may be a surface force generated by molecules on the surface of the structure, a mechanical force/pressure generated with the intervention of the structure in between, a force generated by materials constructing the structure and having different thermal expansion coefficients, an attractive/repulsive force among atoms, or a force generated by ultraviolet (infrared) rays or the like on a surface-treated surface. The transducer is characterized in that it measures a force applied to or generated on the surface of a structure as an electrical signal generated by the change in electromagnetic fields.

### BACKGROUND ART

A transducer using a thin membrane is disclosed in U.S. Pat. No. 5,614,677. The transducer disclosed in the gazette has a substrate and a thin membrane of a dome shape, and the thin membrane is elastically deformed by a force or a pressure applied to the thin membrane. The force or the pressure applied to the thin membrane is measured by measuring electric capacitance varying depending on the elastic deformation of the thin membrane.

A prior technique of the U.S. Pat. No. 5,614,677 is a method of measuring electric capacitance, not a method using an electromagnetic induction phenomenon.

In relation to a method of measuring a load using an electromagnetic induction phenomenon, a high-performance high-sensitivity load measuring transducer for precisely measuring a load or the like using an electromagnetic induction phenomenon is disclosed in Korean Patent Registration No. 10-0500736 and U.S. Pat. Registration No. 7,258,028. This is a method of applying AC current to a fixed gauge to elastically deform a structure by a force or a pressure applied to the structure and measuring the force or the pressure applied to the structure as an electrical signal generated by the change in electromagnetic fields by measuring an output voltage induced by the elastical deformation of the structure at a mobile gauge in accordance with the change in electromagnetic fields.

In addition, a technique of measuring a load or the like using an electromagnetic induction phenomenon is disclosed in Korean Patent Registration No. 10-0919478, in which patterns of two mobile gauges are designed and used to be spaced apart from each other by ¼ pitch in order to overcome the errors caused by the change of input current, eccentricity or the like. In measuring the load, proposed is a method of overcoming such errors by measuring a ratio between induced output voltages, which are electrical signals generated at a first mobile gauge and a second mobile gauge in accordance with the change in electromagnetic fields.

Prior techniques are for measuring a surface force generated by molecules on the surface of a structure, a mechanical force/pressure generated with the intervention of the structure in between, a force generated by materials constructing the structure and having different thermal expansion coefficients, an attractive/repulsive force among atoms, or a force generated by ultraviolet (infrared) rays or the like on a surface-treated surface. Disclosed techniques of the electric capacitance method are limited in implementing a high-performance high-sensitivity transducer, and although disclosed techniques of the method using an electromagnetic induction phenomenon may implement a high-performance high-sensitivity transducer, it is difficult to implement a nano/micro scale transducer using the disclosed structure.

### DISCLOSURE OF THE INVENTION

### Technical Problem

Therefore, the present invention has been made in view of the above problems, and it is an object of the present invention to provide a high-performance high-sensitivity transducer capable of precisely measuring a force applied to or generated on a surface of a structure in a nano/micro scale. Particularly, provided is a transducer capable of performing surface treatment so that specific molecules may be easily adhered to the surface of the structure and capable of measuring a force generated by the adhered molecules.

Another object of the present invention is to provide a transducer for measuring a mechanical force/pressure generated with the intervention of a structure in between, a force generated by materials constructing the structure and having different thermal expansion coefficients, an attractive/repulsive force among atoms, and a force generated by ultraviolet (infrared) rays or the like on a surface-treated surface, in addition to the force generated by the molecules on the surface.

### Technical Solution

In order to accomplish the above-mentioned objects, a force measuring transducer for measuring a force applied to a surface in accordance with the present invention comprises a deformation-producing unit 10 formed in a shape of a cantilever, in which at least one surface is surface-treated to generate a surface force so that elastic deformation may be produced by the force applied to the surface; an input IPA gauge 11 provided inside the deformation-producing unit and formed by repeating an electric wire pattern having a predetermined pitch as many as a predetermined number of times, in which AC current is applied to both ends; a first out gauge 12 and a second output gauge 13 provided at the deformation-producing unit with intervention of the input gauge therebetween and formed by repeating an electric wire pattern having a pitch the same as that of the input gauge as many as a predetermined number of times. Each of the input IPA gauge pattern, the first output IPA gauge pattern and the second output IPA gauge pattern includes a first section 810 extended straight, a second section 820 extended to be perpendicular to the first section, a third section 830 extended to be perpendicular to the second section and parallel to the first section and a pattern connecting section 840. The first section of the first output IPA gauge pattern is provided to be overlapped with the first section of the input IPA gauge pattern. The first section of the second output IPA gauge pattern is provided to be displaced from the first section of the input IPA gauge pattern by ¼ pitch.

The term “IPA gauge” in this specification stands for “Inductance Pattern Analogue Gauge” which means a gauge for measuring a force applied to a surface of a structure or generated force with electric signal due to variation of electromagnetic field by measuring induced voltage in a moving pattern which moves in relative to a stationary pattern where AC current is applied.

Hereinafter, the gauge means IPA gauge.

A surface provided with the first output gauge and the second output gauge in the deformation-producing unit 90 is formed as concave-convex unit.

The deformation-producing unit 30 includes a supporting unit 40a, 301 fixed to a fixing unit 1 and a body unit extended from an end of the supporting unit to have a shape of a circle. The other end of the body unit may be a free end.

The other end of the body unit may be fixed to the fixing unit.

The deformation-producing unit 40 includes a supporting unit fixed to a fixing unit 1 and a body unit extended from an end of the supporting unit to have a shape of a spiral. The other end of the body unit may be a free end.

The other end of the body unit may be fixed to the fixing unit.

A force measuring transducer for measuring a force applied to a surface in accordance with another embodiment of the present invention comprises a deformation-producing unit 41 including a supporting unit fixed to a fixing unit 1 and a body unit extended from an end of the supporting unit to have a shape of a circle, in which the other end of the body unit is a free end, and at least one surface is surface-treated to generate a surface force so that elastic deformation may be produced by the force applied to the surface; an input gauge 11 provided at the deformation-producing unit and formed by repeating an electric wire pattern having a predetermined pitch as many as a predetermined number of times, in which AC current is applied to both ends; a first member 42 provided inside the deformation-producing unit and including a supporting unit fixed to the fixing unit 1 and a body unit extended from and end of the supporting unit to have a shape of a circle, in which the other end of the body unit is fixed to the fixing unit; a second member 43 provided outside the deformation-producing unit and including a supporting unit fixed to the fixing unit 1 and a body unit extended from an end of the supporting unit to have a shape of a circle, in which the other end of the body unit is fixed to the fixing unit; a first output gauge 12 and a second output gauge 13 provided at the first member and the second member with intervention of the input gauge therebetween and formed by repeating an electric wire pattern having a pitch the same as that of the input gauge as many as a predetermined number of time. Each of the input gauge pattern, the first output gauge pattern and the second output gauge pattern includes a first section extended straight, a second section extended to be perpendicular to the first section, a third section extended to be perpendicular to the second section and parallel to the first section and a pattern connecting section extended to be perpendicular to the third section. The first section of the first output gauge pattern is provided to be overlapped with the first section of the input gauge pattern, and the first section of the second output gauge pattern is provided to be displaced from the first section of the input gauge pattern by ¼ pitch.

The other end of the body unit may be fixed to the fixing unit.

A force measuring transducer for measuring a force applied to a surface in accordance with another embodiment of the present invention comprises a deformation-producing unit 51 including a supporting unit fixed to a fixing unit and a body unit extended from an end of the supporting unit to have a shape of a spiral, in which the other end of the body unit is a free end, and at least one surface is surface-treated to generate a surface force so that elastic deformation may be produced by the force applied to the surface; an input gauge provided at the deformation-producing unit and formed by repeating an electric wire pattern having a predetermined pitch as many as a predetermined number of times, in which AC current is applied to both ends; a first member 52 provided inside the deformation-producing unit and including a supporting unit fixed to the fixing unit and a body unit extended from an end of the supporting unit to have a shape of a spiral, in which the other end of the body unit is fixed to the fixing unit; a second member 53 provided outside the deformation-producing unit and including a supporting unit fixed to the fixing unit and a body unit extended from an end of the supporting unit to have a shape of a spiral, in which the other end of the body unit is fixed to to fixing unit; a first output gauge and a second output gauge provided at the first member and the second member with intervention of the input gauge therebetween and formed by repeating an electric wire pattern having a pitch the same as that of the input gauge as many as a predetermined number of times. Each of the input gauge pattern, the first output gauge pattern and the second output gauge pattern includes a first section extended straight, a second section extended to be perpendicular to the first section, a third section extended to be perpendicular to the second section and parallel to the first section and a pattern connecting section extended to be perpendicular to the third section. The first section of the first output gauge pattern is provided to be overlapped with the first section of the input gauge pattern. The first section of the second output gauge pattern is provided to be displaced from the first section of the input gauge pattern by ¼ pitch.

The other end of the body unit may be a free end.

A force measuring transducer for measuring a force applied to a surface in accordance with another embodiment of the present invention comprises a deformation-producing unit 70 having a shape of a circular plate where elastic deformation is produced by the force applied to the surface; an input gauge 71 provided inside the deformation-producing unit and formed by repeating an electric wire pattern having a predetermined pitch as many as a predetermined number of times, in which AC current is applied to both ends; a first output gauge 73 and a second output gauge 72 provided at the deformation-producing unit with intervention of the input gauge therebetween and formed by repeating an electric wire pattern having a pitch the same as that of the input gauge as many as a predetermined number of times. Each of the input gauge pattern, the first output gauge pattern and the second output gauge pattern includes a first section 85 extended straight, a second section 86 extended from an end of the first section in a shape of a circle, a third section 87 extended straight in a direction the same as that of the first section and a fourth section 88 extended in a direction opposite to that of the second section in a shape of a circle. The second section of the first output gauge pattern is provided to be overlapped with the second section of the input gauge pattern. The second section of the second output gauge pattern is provided to be displaced from the second section of the input gauge pattern by ¼ pitch.

The outer surface of the deformation-producing unit is fixed to the fixing unit 1.

A force measuring transducer for measuring a force applied to a surface in accordance with another embodiment of the present invention comprises a deformation-producing unit 801 having an outer surface formed in a shape of a circular plate fixed to a fixing unit, in which elastic deformation is produced by the force applied to the surface; a fixing member 802 having an outer surface formed in a shape of a circular plate fixed to the fixing unit 1, provided to be parallel to the deformation-producing unit 801, and provided with at least one or more penetrating holes; an input gauge 81 provided at the fixing member 802 and formed by repeating an electric wire pattern having a predetermined pitch as many as a predetermined number of times, in which AC current is applied to both ends; a first output gauge 82 and a second output gauge 83 provided at the fixing member 802 and the deformation-producing unit 801 with intervention of the input gauge 81 therebetween and formed by repeating an electric wire pattern having a pitch the same as that of the input gauge as many as a predetermined number of times. Each of the input gauge pattern, the first output gauge pattern and the second output gauge pattern includes a first section 85 extended straight, a second section 86 extended from an end of the first section in a shape of a circle, a third section 87 extended straight in a direction the same as that of the first section and a fourth section 88 extended in a direction opposite to that of the second section in a shape a circle. The second section of the first output gauge pattern is provided to be overlapped with the second section of the input gauge pattern, and the second section of the second output gauge pattern is provided to be displaced from the second section of the input gauge pattern by ¼ pitch.

A force measuring transducer for measuring a force applied to a surface in accordance with another embodiment of the present invention with each gauge having no zigzag pattern comprises a deformation-producing unit 61 including a supporting unit fixed to a fixing unit and a body unit extended from an end of the supporting unit to have a shape of a circle, in which the other end of the body unit is fixed to the fixing unit, and at least one surface is surface-treated to generate a surface force so that elastic deformation may be produced by the force applied to the surface and an input gauge provided at the deformation-producing unit, in which AC current is applied to both ends; a first member 62 provided inside the deformation-producing unit and including a supporting unit fixed to the fixing unit and a body unit extended from an end of the supporting unit to have a shape of a circle, in which the other end of the body unit is fixed to the fixing unit; a second member 63 provided outside the deformation-producing unit and including a supporting unit fixed to the fixing unit and a body unit extended from an end of he supporting unit to have a shape of a circle, in which the other end of the body unit is fixed to the fixing unit; and a first output gauge and a second output gauge provided at the first member and the second member, respectively. The input gauge has the same shape of the deformation-producing unit. If the input gauge is elastically-deformable, the deformation-producing unit can be substituted by the input gauge. The first output gauge and the second output gauge have the same shape of the first member and to second member, respectively. The first member and the second member can be substituted by the first output gauge and the second output gauge, respectively.

The other end of the body unit may be fixed to the fixing unit.

A force measuring transducer for measuring a force applied to a surface in accordance with another embodiment of the present invention comprises a deformation-producing unit formed in a shape of a cantilever, in which at least one surface is surface-treated to generate a surface force so that elastic deformation may be produced by the force applied to the surface; a fixing member provided to be parallel to the deformation-producing unit; an input gauge 11 provided at the deformation-producing unit and formed by repeating an electric wire pattern having a predetermined pitch as many as a predetermined number of times, in which AC current is applied to both ends; a first output gauge 12 and a second output gauge 13 provided at the deformation-producing unit and the fixing member with intervention of the input gauge therebetween and formed by repeating an electric wire pattern having a pitch the same as that of the input gauge as many as a predetermined number of times. Each of the input gauge pattern, the first output gauge pattern and the second output gauge pattern includes a first section 810 extended straight, a second section 820 extended to be perpendicular to the first section, a third section 830 extended to be perpendicular to the second section and parallel to the first section and a pattern connecting section 840 extended to be perpendicular to the third section. The first section of the first output gauge pattern is provided to be overlapped with the first section of the input gauge pattern, and the first section of the second output gauge pattern is provided to be displaced from the first section of the input gauge pattern by ¼ pitch.

A force measuring transducer for measuring a force applied to a surface in accordance with another embodiment of the present invention comprises a deformation-producing unit 220, 230 formed in a shape of a cantilever with a proving tip at the end thereof, in which elastic deformation is produced by a force applied to the probing tip; a fixing member 221, 231 provided to be parallel to the deformation-producing unit; an input gauge 11 provided at the deformation-producing unit or the fixing member and formed by repeating an electric wire pattern having a predetermined pitch as many as a predetermined number of times, in which AC current is applied to both ends; a first output gauge 12 and a second output gauge 12 provided at the fixing member or the deformation-producing unit and formed by repeating an electric wire pattern having a pitch the same as that of the input gauge as many as a predetermined number of times. Each of the input gauge pattern, the first output gauge pattern and the second output gauge pattern includes a first section 810 extended straight, a second section 820 extended to be perpendicular to the first section, a third section 830 extended to be perpendicular to the second section and parallel to the first section and a pattern connecting section 840 extended to be perpendicular to the third section. The first section of the first output gauge pattern is provided to be overlapped with the first section of the input gauge pattern, and the first section of the second output gauge pattern is provided to be displaced from the first section of the input gauge pattern by ¼ pitch.

The first output gauge pattern may be provided to be overlapped with the input gauge pattern and the second output gauge pattern may be provided to be displaced from the input gauge pattern by ¼ pitch.

Further, the applied force is measured through a ratio between magnitude of induction voltage measured by the first output gauge and magnitude of induction voltage measured by the second output gauge.

### Advantageous Effects

According to the present invention so configured, there is provided a high-performance high-sensitivity transducer for precisely measuring a force applied to or generated on the surface of a specific structure in a nano/micro scale.

In addition, the transducer of the present invention has as a very simple configuration, consumes a small amount of power, is small in size and light in weight and can be highly integrated, and thus mass production can be achieved at a low manufacturing cost in conjunction with silicon-based (semiconductor-based) techniques.

In an embodiment of the present invention, surface treatment is performed so that specific molecules may be easily adhered to the surface of a specific structure, and thus the adhered molecules can be accurately measured. This is effective in enhancing accuracy of an apparatus which detects a specific molecule in blood, environmental pollutants (water pollutants, air pollutants or the like), dangerous materials (explosives, drugs or the like) or the like.

In addition, as another embodiment of the present invention, it is effective in that a pressure, a temperature, an attractive/repulsive force among atoms or density of ultraviolet (infrared) rays having a very high resolution can be measured in a nano/micro scale.

### BRIEF DESCRIPTION OF THE DRAWINGS

FIG. 1 is a perspective view showing a gauge pattern used in the present invention.

FIG. 2 is a plan view showing a gauge pattern used in the present invention before deformation.

FIG. 3 is a plan view showing a gauge pattern used in the present invention after deformation.

FIG. 4 is a conceptual view showing change of voltage measured before deformation in the present invention.

FIG. 5 is a conceptual view showing change of voltage measured after deformation in the present invention.

FIG. 6 is a plan view showing a gauge pattern used in the present invention.

FIG. 7 is a cross-sectional view showing a force measuring transducer according to an embodiment of the present invention.

FIG. 8 is a cross-sectional view showing a force measuring transducer according to an embodiment of the present invention.

FIG. 9 is a view illustrating the principle of a force measuring transducer according to an embodiment of the present invention.

FIG. 10 is a view illustrating a method of manufacturing a force measuring transducer according to an embodiment of the present invention.

FIGS. 11 to 13 are cross-sectional views showing a force measuring transducer according to an embodiment of the present invention.

FIG. 14 is a cross-sectional view showing a force measuring transducer according to another embodiment of the present invention.

FIG. 15 is a cross-sectional view showing a force measuring transducer according to another embodiment of the present invention.

FIG. 16 is a cross-sectional view showing a force measuring transducer according to another embodiment of the present invention.

FIG. 17 is a perspective view showing a force measuring transducer according to another embodiment of the present invention.

FIGS. 18 and 19 are cross-sectional views showing a force measuring transducer according to another embodiment of the present invention.

FIG. 20 is a cross-sectional view showing a force measuring transducer according to another embodiment of the present invention.

FIG. 21 is a cross-sectional view showing a force measuring transducer according to another embodiment of the present invention.

FIG. 22 is a cross-sectional view showing a force measuring transducer according to another embodiment of the present invention.

FIGS. 23 and 24 are cross-sectional views showing a force measuring transducer according to another embodiment of the present invention.

FIGS. 25 and 26 are plan views showing a force measuring transducer according to another embodiment of the present invention.

FIGS. 27 and 28 are plan views showing a force measuring transducer according to another embodiment of the present invention.

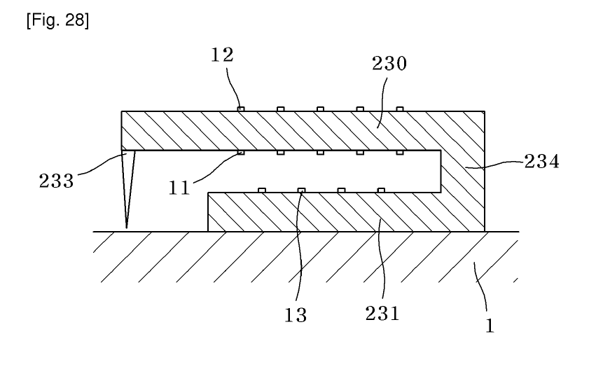

### MODE FOR CARRYING OUT THE INVENTION

The present invention will be hereafter described in detail with reference to the accompanying drawings.

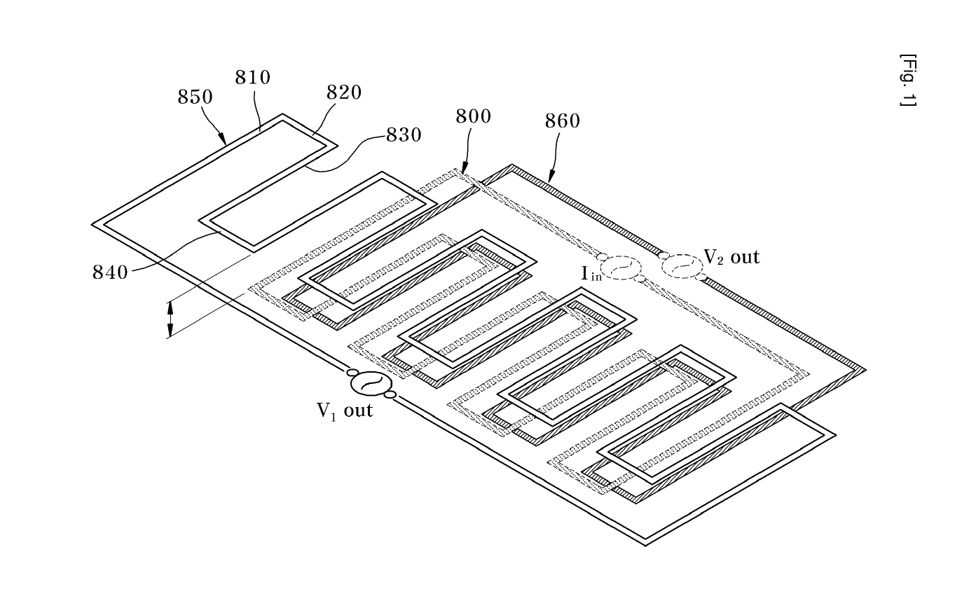

The present invention uses an electromagnetic induction phenomenon, and a principle thereof will be described with reference to FIGS. 1 to 5.

As shown in FIG. 1, gauges which produce an electromagnetic induction phenomenon used in the present invention include an input gauge 800, and a first output gauge 850 and a second output gauge 860 disposed so as to move with respect to the input gauge 800. Actually, the input gauge 800, the first output gauge 850 and the second output gauge 860 are formed at different positions of a structure, and the first output gauge 850 and the second output gauge 860 are provided at both sides of the intervening input gauge 800. The structure is not shown for the convenience of explanation. It is preferable to install the gauges so that the distance between the input gauge 800 and the first output gauge 850 may be equal to the distance between the input gauge 800 and the second output gauge 860.

The input gauge 800, the first output gauge 850 and the second output gauge 860 are respectively formed as a repeating pattern, and each of the patterns includes a first section 810 extended straight, a second section 820 extended from one end of the first section 810 to be perpendicular to the first section, and a third section 830 extended from one end of the second section 820 to be perpendicular to the second section 820 and parallel to the first section 810. Such a pattern is repetitively extended, and a connecting section 840 of each pattern is extended to be perpendicular to the third section 830 and connects the patterns. Each pattern has a pitch, and pitches of the input gauge 800 and the output gauges are preferably equal to each other.

AC current having regular cycles and amplitude is applied to both ends of the input gauge 800. If the first output gauge 850 and the second output gauge 860 are moved by the applied force in relation to the input gauge 800, positions of the first output gauge 850 and the second output gauge 860 relative to that of the input gauge are changed within the electromagnetic field formed at the input gauge. Accordingly, intensity of the electromagnetic field affected on the first output gauge 850 and the second output gauge 860 is changed, and output voltages induced at the first output gauge 850 and the second output gauge 860 are changed by the electromagnetic induction phenomenon.

The basic principle of the present invention is measuring relative displacements between the input gauge 800 and the first and second output gauges 850 and 860 produced by the force applied to the surface of the structure by measuring a difference between the changes in the output voltages induced by the electromagnetic induction phenomenon.

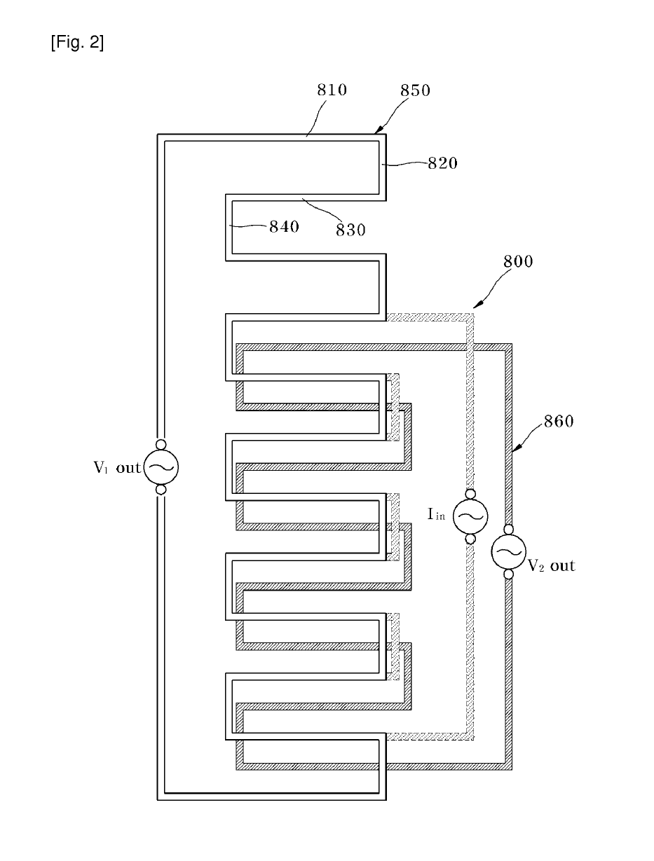

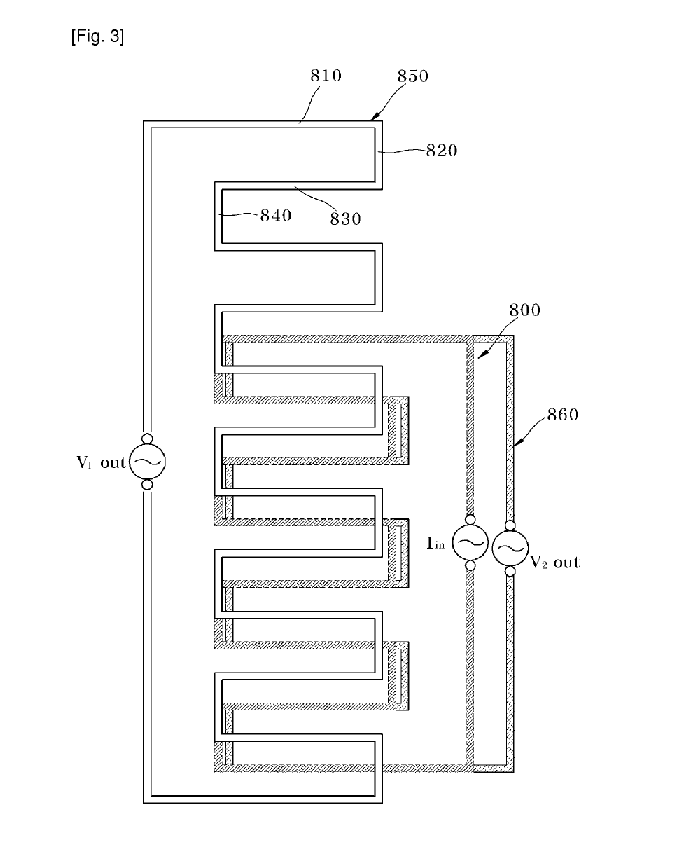

FIG. 2 is a plan view before a displacement is produced between gauges, and FIG. 3 is a plan view after a displacement is produced between gauges.

The only difference is that the patterns of the first output gauge 850 and the second output gauge 860 are designed to be displaced from each other by ¼ pitch, and although an error occurs due to the changes in the input current, eccentricity or the like, the ratio between the output voltages induced at the first output gauge 850 and the second output gauge 860 does not change.

Accordingly, the basic principle of the present invention is measuring an applied load and force by measuring a ratio between the output voltages induced at the first output gauge 850 and the second output gauge 860 and measuring relative displacements between the input gauge and the output gauges.

Hereinafter, a method of measuring an applied force by measuring a ratio between the output voltages induced at the two output gauges 850 and 860 will be described in further detail. In the present invention, the input gauge, the first output gauge and the second output gauge may be provided at the same structure or at structures separate from one another. However, a case of providing the input gauge, the first output gauge and the second output gauge at the same structure will be described as an example for the convenience of explanation.

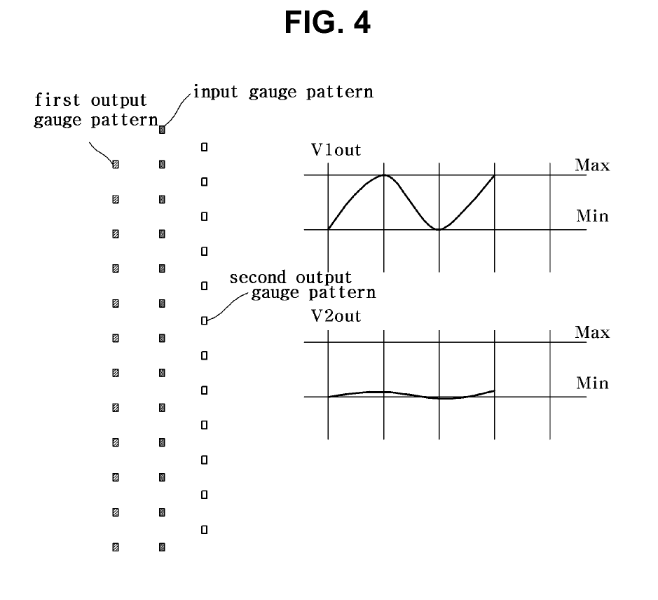

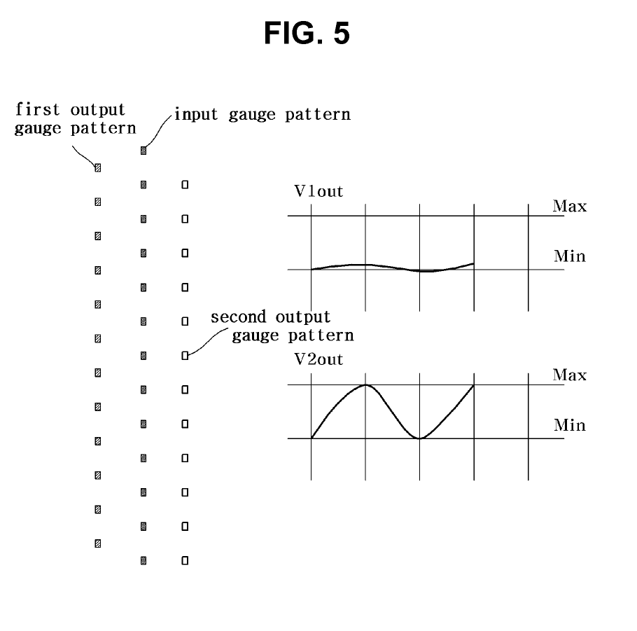

FIGS. 4 and 5 show changes of output induction voltage values according to relative positions of gauges. A portion of the structure where an input gauge is provided is referred to as an input unit, and a portion of the structure where an output gauge is provided is referred to as an output unit. FIGS. 4 and 5 are views showing cross-sections cut down in the middle of the input unit and the output unit, in which vertical connection parts of the wire pattern are not shown, and the structure thereof is omitted from the figure.

When no force is applied to the structure in the initial stage, horizontal wires of the input gauge 800 are overlapped with horizontal wires of the first output gauge 850. In addition, horizontal wires of the second output gauge 860 are positioned to be displaced from the above wires by ¼ pitch. In this case, an induction voltage V1out of an AC waveform, which has a cycle the same as that of the AC current applied to the input gauge 800 and maximum amplitude, is outputted from the first output gauge 850. Induction voltage V2out outputted from the second output gauge 860 is almost nothing due to the interference between the first section and the third section of the wire of the input gauge 800. However, V2out is only relatively smaller than V1out, and an induction voltage having an AC waveform of the same cycle is outputted actually.

If a force is applied to the structure, gauges of the input unit and the output unit are moved due to deformation of the structure according to the applied force, and patterns of the gauges are displaced from each other. If patterns of the output unit are moved to be displaced by ¼ pitch, V2out becomes an induction voltage of an AC waveform having maximum amplitude, and V1out becomes an induction voltage of an AC waveform having a value relatively smaller than that of V2out.

When a force is calculated by measuring an absolute value of the induction voltage using only one input gauge, the absolute value of the induction voltage varies depending on the distance between the relative positions of the input gauge and the output gauge. In this case, if the input current is changed although the distance between the input gauge and the output gauge is not changed since the applied force is not changed, the absolute value of the outputted induction voltage is changed, and an error occurs due to the change of the input current as a result.

When a ratio between the output gauges is measured using two output gauges, such an error can be removed. That is, although the input current is changed, a ratio between V1out and V2out will have a constant value depending on the distances between the input gauge and two output gauges. The principle is the same as that of a right-angled triangle in which although the size of the triangle is changed, the tangent value is constant if its angle is constant.

The principle of measuring an applied force by measuring a ratio between output voltages induced at the two output gauges using an electromagnetic induction phenomenon is described above. Hereinafter, a specific embodiment of the present invention will be described in detail.

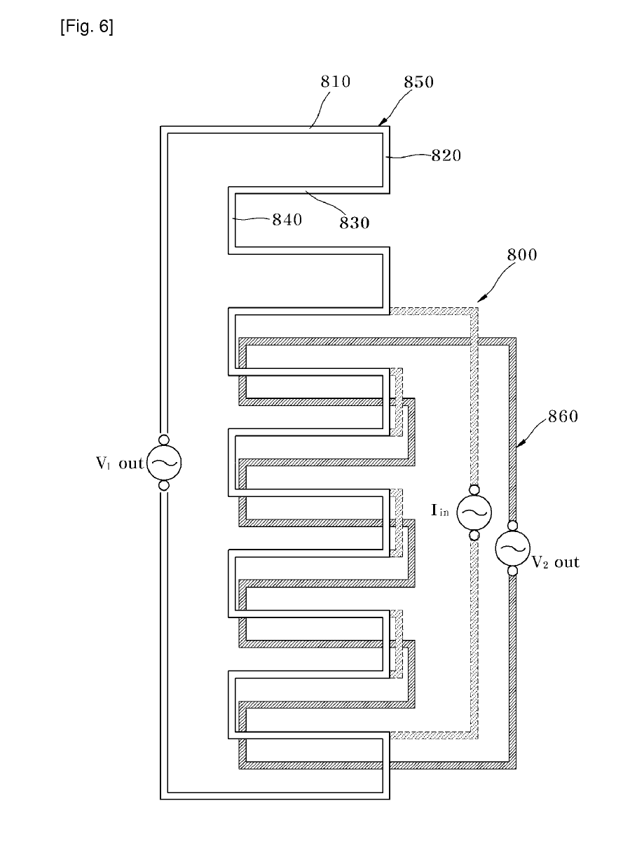

FIG. 6 shows patterns of gauges provided in an embodiment of the present invention. A first output gauge 850 and a second output gauge 860 are provided at both sides of an intervening input gauge 800.

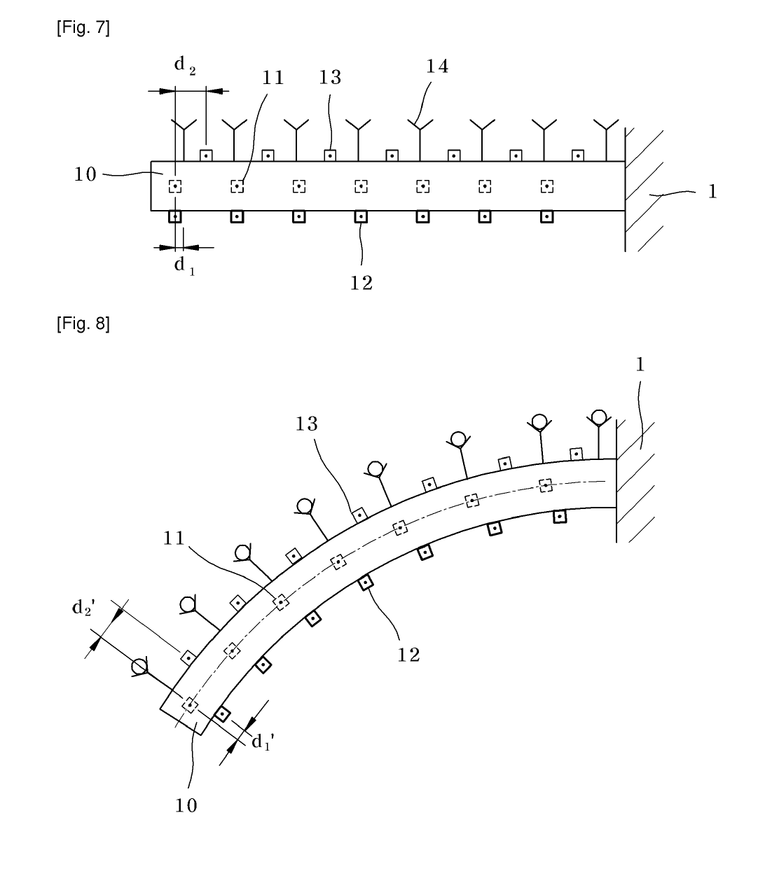

FIG. 7 is a cross-sectional view shown from the side before deformation in this embodiment. FIG. 7 is a view showing the patterns of the gauges cut in the vertical direction.

The structure provided with the gauges is expressed as a deformation-producing unit 10 where elastic deformation is produced by a force applied to the surface of the structure. The Y-shaped symbols 14 on one surface of the deformation-producing unit 10 show a surface-treated state which allows specific molecules to be easily adhered. In the present invention, the meaning of being surface-treated to generate a surface force is, for example, that a surface treatment such as a coating or the like is performed so that specific molecules may be adhered to the surface, and a surface force is generated by the force acting among the molecules after the molecules are adhered. Other than this, it means that the surface is treated so as to generate a stress or a force in response to an external stimulus.

It is preferable that the deformation-producing unit 10 is formed in a plate type having a shape and a width of a cantilever, one end of which is fixed to a fixing unit 1. An input gauge is provided inside the deformation-producing unit 10 in the shape of the pattern described above, and this is expressed as reference numeral 11 on the cross-section cut in the vertical direction.

A first output gauge 12 and a second output gauge 13 are provided at both sides of the deformation-producing unit 10 in a pattern of a pitch the same as that of the input gauge 11. At this point, it is preferable that either of the two output gauges is provided to have a pattern exactly overlapped with that of the input gauge 11, and the other output gauge is provided to be displaced by ¼ pitch. In this manner, voltage values outputted from the output gauges have a phase difference of ¼.

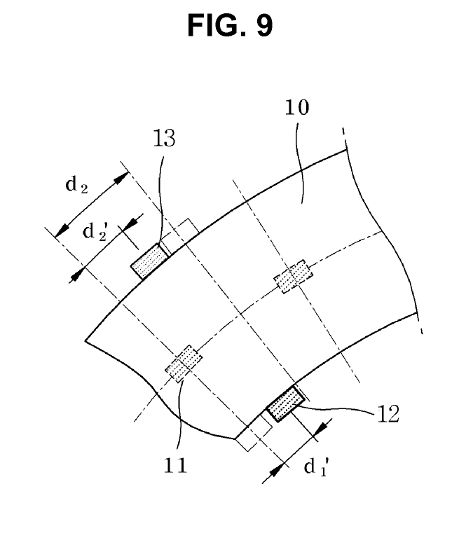

FIG. 8 is a cross-sectional view shown from the side after deformation in an embodiment of the present invention. The deformation-producing unit 10 is elastically deformed and bent by a force applied to the surface, such as a surface stress or force generated by the force among the molecules adhered to the surface of the surface-treated deformation-producing unit 10.

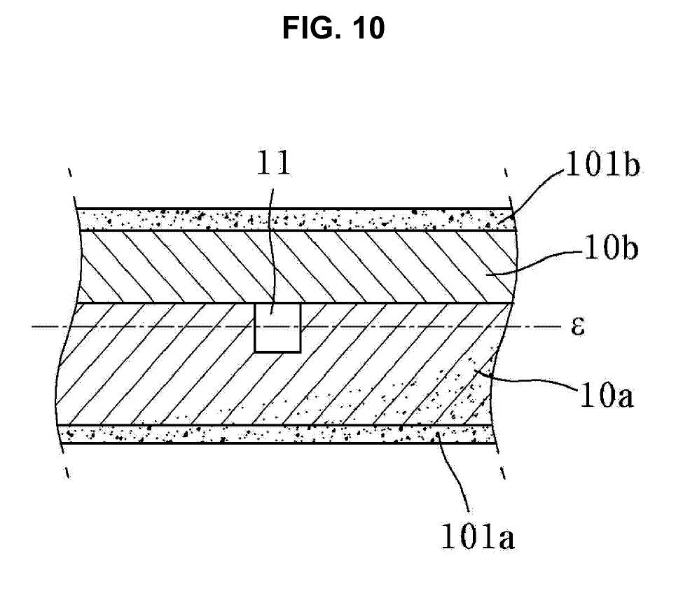

FIG. 9 is an enlarged cross-sectional view showing a bent state of the deformation-producing unit 10. The input gauge 11 is preferably placed on the neutral axis. The position of the input gauge 11 placed on the neutral axis does not change although the deformation-producing unit 10 is bent, since the neutral axis is not changed. However, when the deformation-producing unit 10 is bent, the distance between the second output gauge 13 placed outside the neutral axis and the input gauge 11 is decreased by ¼ pitch, and the distance between the first output gauge 12 placed inside the neutral axis and the input gauge 11 is increased to be larger than the initial distance. Such a phenomenon is apparent to those skilled in the art of the solid mechanics and is described in detail in the solid mechanics textbook of Timoshenko.

Accordingly, output voltage V1out is decreased since the distance between the patterns of the input gauge and the first output gauge is increased, and output voltage V2out is increased since the distance between the patterns of the input gauge and the second output gauge is decreased.

Accordingly, magnitude of bending may be calculated through a ratio between magnitudes of V1out and V2out, and magnitude of the force applied to the deformation-producing unit may be calculated through the magnitude of bending.

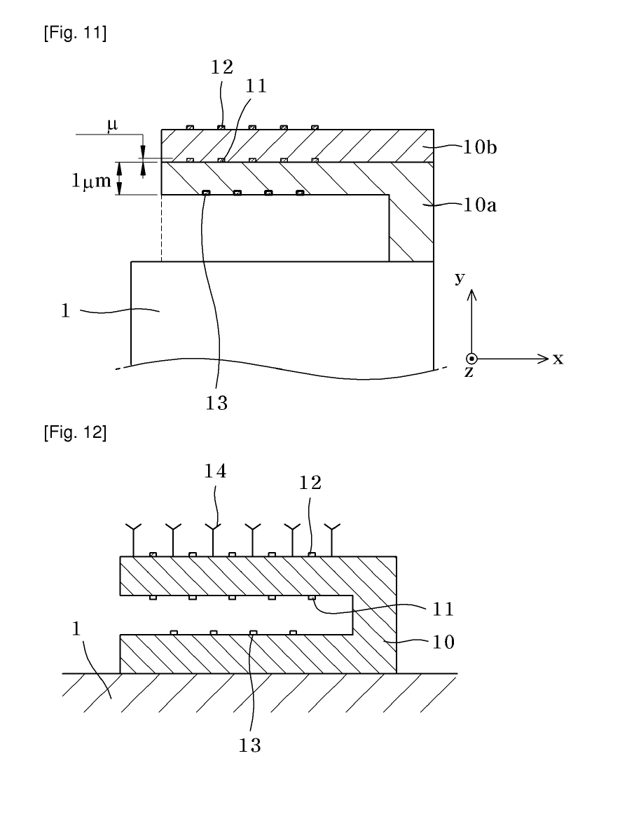

FIG. 10 is a view illustrating a method of providing an input gauge 11 at the deformation-producing unit 10. The pattern of the input gauge 11 is formed in a first part 10a of the deformation-producing unit 10. Next, it is preferable to manufacture the deformation-producing unit 10 in a method of further providing a second part 10b. At this point, the first part 10b and the second part 10a are preferably formed of the same material so as to have the same heat transfer coefficient.

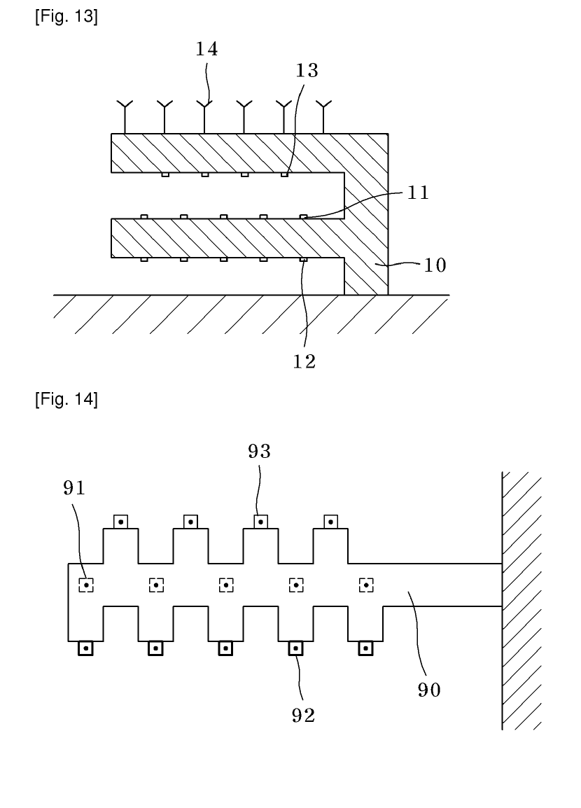

FIGS. 11 to 13 are cross-sectional views showing other embodiments in which a deformation-producing unit 10 is provided to have a different shape. Since the principle is the same as that of the embodiment described in FIG. 7, it will be omitted. However, the electromagnetic induction phenomenon produced among the gauges may be affected by the force of the molecules adhered to one side of the deformation-producing unit 10. This may affect a value measured at the output gauges. In this case, the first output gauge 12 may be coated with an electric shield material so that the force of the molecules may not affect the electromagnetic induction phenomenon. This is the same for the embodiment described in FIG. 7.

The force measuring transducer is formed in a shape of a cantilever, at least one side of which is surface-treated so that a surface force may be generated, and is provided with the deformation-producing unit where elastic deformation is produced by a force applied to the surface and a fixing member that is parallel to the deformation-producing unit.

In FIGS. 12 and 13, the input gauge 11 is provided at the deformation-producing unit or the fixing unit and is formed by repeating an electric wire pattern having a predetermined pitch as many as a predetermined number of times, and AC current is applied to both ends of the input gauge. The first output gauge 12 is provided at the deformation-producing unit or the fixing unit and is formed by repeating an electric wire pattern having a pitch the same as that of the input gauge as many as a predetermined number of times. The second output gauge 13 is provided at the fixing unit or the deformation-producing unit and is formed by repeating an electric wire pattern having a pitch the same as that of the input gauge as many as a predetermined number of times. Since the measuring principle is the same as described above, it will be omitted.

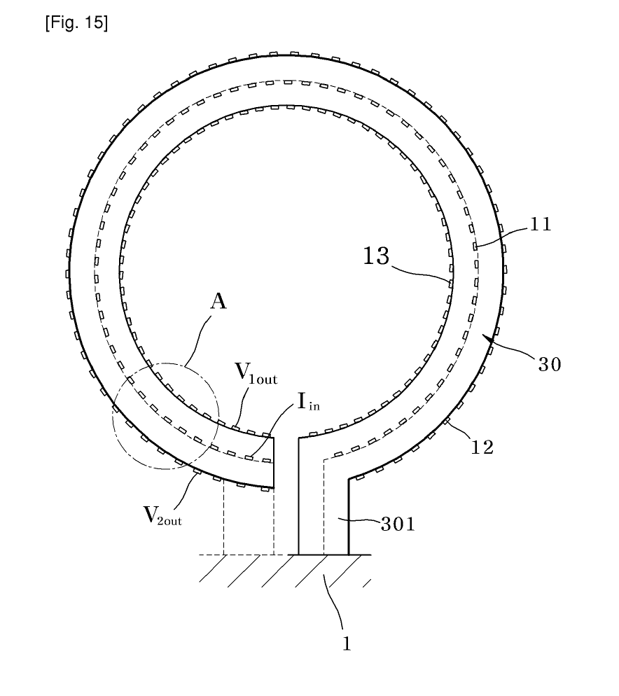

FIG. 14 is a cross-sectional view showing another embodiment in which a deformation-producing unit 90 is provided to have a concave-convex shape. If the cross-section of the deformation-producing unit 90 is formed as described above, a further larger force may be obtained by increasing the number of molecules adhered to the surface, or the deformation may be easily produced, or changes in the relative positions of the input gauge and the output gauges may be increased. Therefore, it is effective in that the measuring resolution is improved.

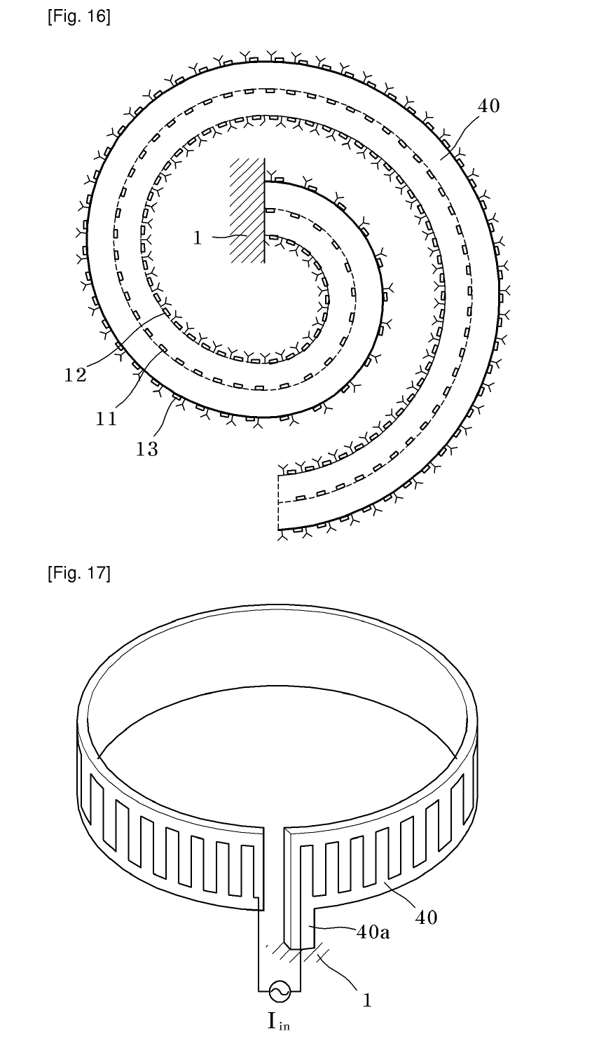

FIG. 15 is a view showing another embodiment of the force measuring transducer according to the present invention, and a deformation-producing unit 30 includes a supporting unit 301 and a body unit extended from one end of the supporting unit to have a shape of a circle. The other end of the body unit is provided as a free end or a fixed end. At this point, the supporting unit 301 is preferably fixed to a fixing unit 1.

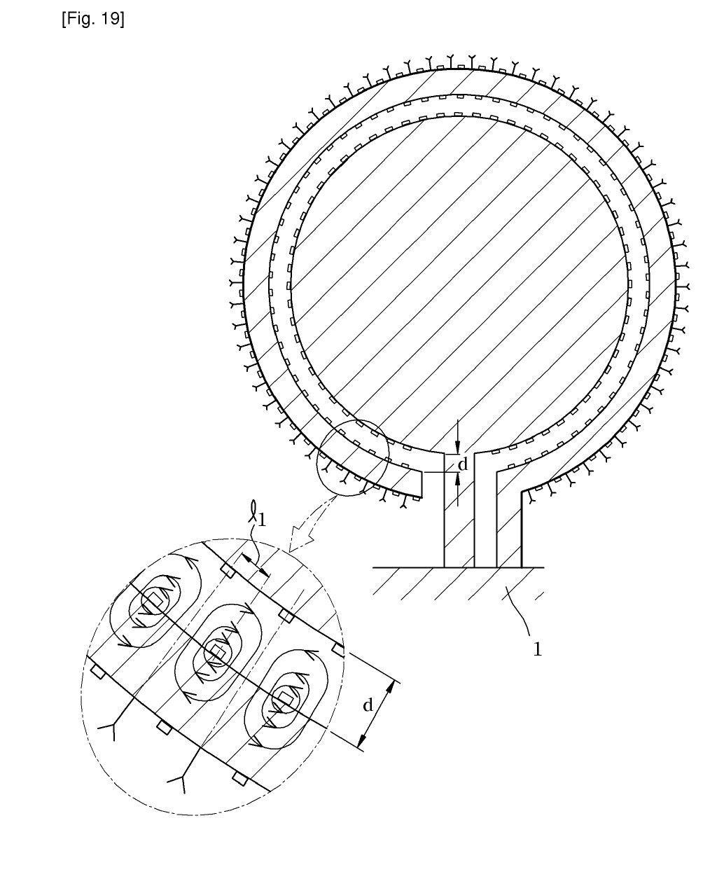

Only the shape of the deformation-producing unit is different from that of the embodiment of FIG. 7, and its structure and principle are the same. It is general that inside, outside or both sides of the deformation-producing unit 10 are preferably surface-treated so that a surface force may be easily generated (e.g., specific molecules may be easily adhered). FIG. 17 is a perspective view showing such gauges and a deformation-producing unit or member. Since the operating and measuring principles are the same as described above, details thereof will be omitted.

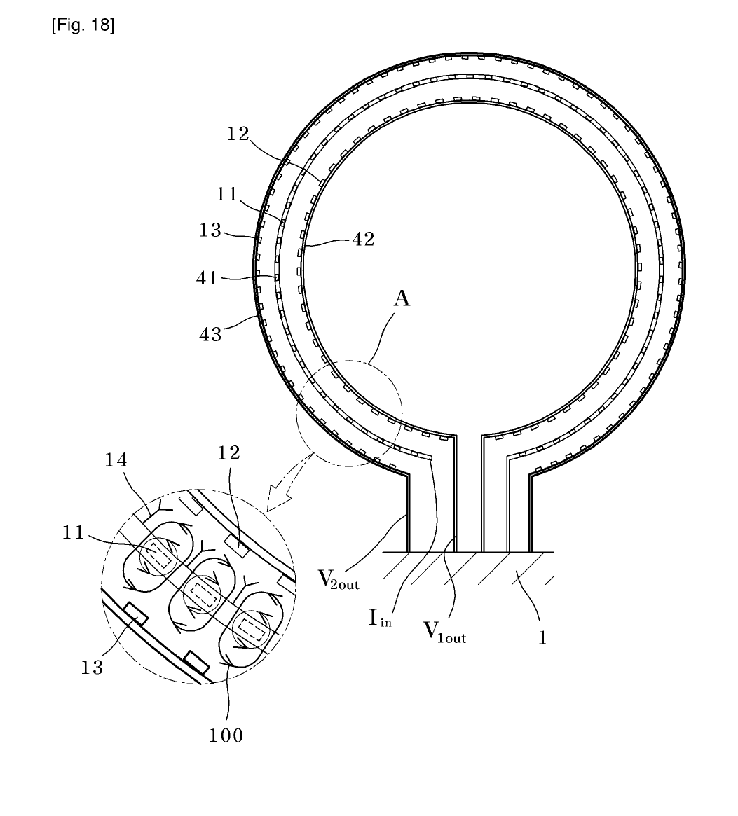

FIG. 16 is a view showing still another embodiment of the force measuring transducer according to the present invention, and a deformation-producing unit 40 includes a supporting unit fixed to a fixing unit 1 and a body unit extended from one end of the supporting unit to have a shape of a spiral. The other end of the body unit is provided as a free end or a fixed end.

Although it is shown in FIG. 16 that surface treatment for adhering specific molecules is provided on both sides of the deformation-producing unit 40, it can be provided only on one side thereof. Since the operating and measuring principles are the same as described above, details thereof will be omitted.

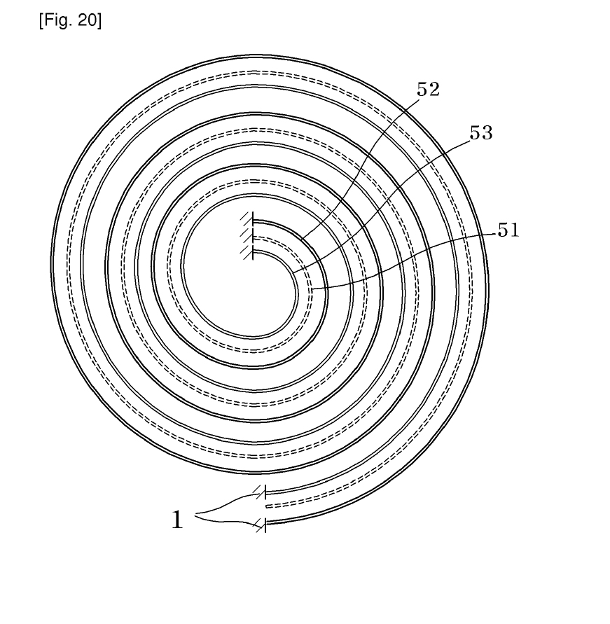

FIG. 18 is a view showing still another embodiment of a force measuring transducer according to the present invention, and an input gauge 11 is provided at the deformation-producing unit 41 that includes a supporting unit fixed to a fixing unit 1 and a body unit extended from one end of the supporting unit to have a shape of a circle. The other end of the body unit may be provided as a free end or a fixed end, and the input gauge 11 is provided at a deformation-producing unit 41, at least one side of which is surface-treated so that a force may be generated.

A first output gauge 12 is provided inside the deformation-producing unit that includes a supporting unit fixed to the fixing unit 1 and a body unit extended from one end of the supporting unit to have a shape of a circle. The other end of the body unit is provided at a first member fixed to the fixing unit 1.

A second output gauge 13 is provided outside the deformation-producing unit that includes a supporting unit fixed to the fixing unit 1 and a body unit extended from one end of the supporting unit to have a shape of a circle. The other end of the body unit is provided at a second member fixed to the fixing unit 1.

FIG. 17 is a perspective view showing such gauges and a deformation-producing unit or member.

Although it is shown in FIG. 18 that only the inner surface of the deformation-producing unit 41 is surface-treated in order to easily adhere molecules thereon, it is not limited thereto. If the surface treatment is provided only on the inner surface of the deformation-producing unit 41, molecules are adhered thereon, and a surface stress is generated thereby, and thus a bending deformation is produced at the deformation-producing unit 41, and patterns of the output gauges displaced from that of the input gauge. Therefore, since induced output voltages are changed and spaces between the input gauge 11 and the first and second output gauges 12 and 13 are different, there is a difference between the induced output voltages. It is possible to measure the magnitude of a force applied to the surface of the deformation-producing unit 41 using a ratio between the output voltages.

FIG. 19 is a view showing still another embodiment of a force measuring transducer according to the present invention, and an input gauge includes a supporting unit fixed to a fixing unit 1 and a body unit extended from one end of the supporting unit to have a shape of a circle. The other end of the body unit may be provided as a free end or a fixed end, and the input gauge 11 is provided at a deformation-producing unit, at least one side of which is surface-treated so that a force may be generated. A fixing member is provided in a shape of a circular plate having a concentric circle in parallel to the deformation-producing unit.

A first output gauge is provided at the fixing member inside the deformation-producing unit.

A second output gauge is provided outside the deformation-producing unit.

Although it is descried in FIG. 19 that only the outer surface of the deformation-producing unit is surface-treated in order to easily adhere molecules thereon, it is not limited thereto. Since the operating and measuring principles are the same as described above, details thereof will be omitted.

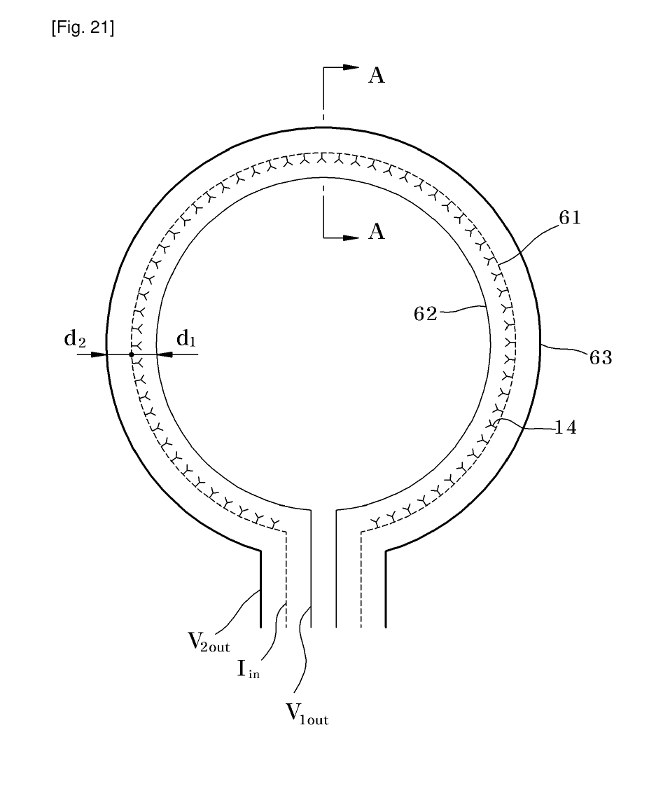

FIG. 20 shows another form of the embodiment provided in FIG. 17, and a deformation-producing unit 51 provided with an input gauge includes a supporting unit fixed to a fixing unit and a body unit extended from one end of the supporting unit to have a shape of a spiral. The other end of the body unit is provided as a free end or a fixed end. At least either side of the deformation-producing unit 51 is surface-treated so that a force may be generated.

A first output gauge 53 is provided inside the deformation-producing unit that includes a supporting unit fixed to the fixing unit and a body unit extended from one end of the supporting unit to have a shape of a spiral. The other end of the body unit is provided at a first member fixed to the fixing unit.

A second output gauge 52 is provided outside the deformation-producing unit that includes a supporting unit fixed to the fixing unit and a body unit extended from one end of the supporting unit to have a shape of a spiral. The other end of the body unit is provided to a second member fixed to the fixing unit.

Since the operating and measuring principles are the same as described above, details thereof will be omitted.

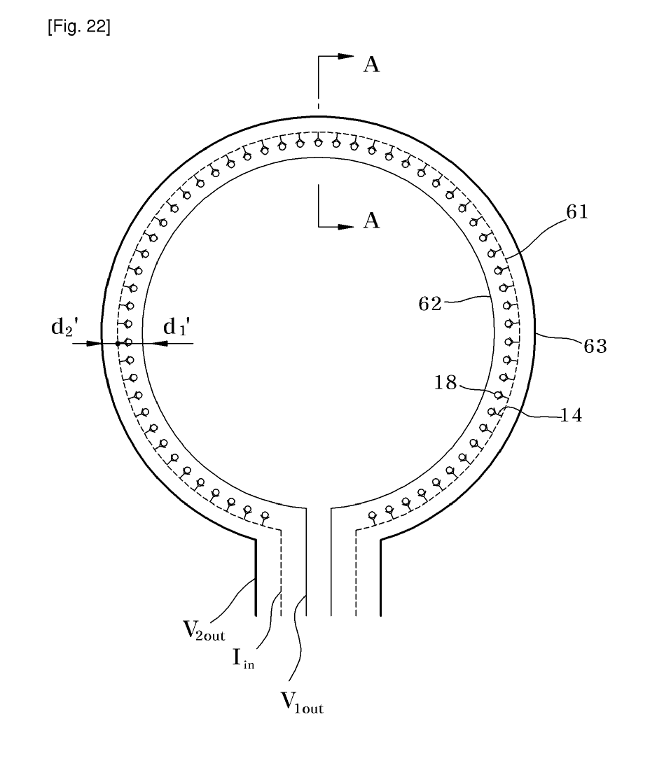

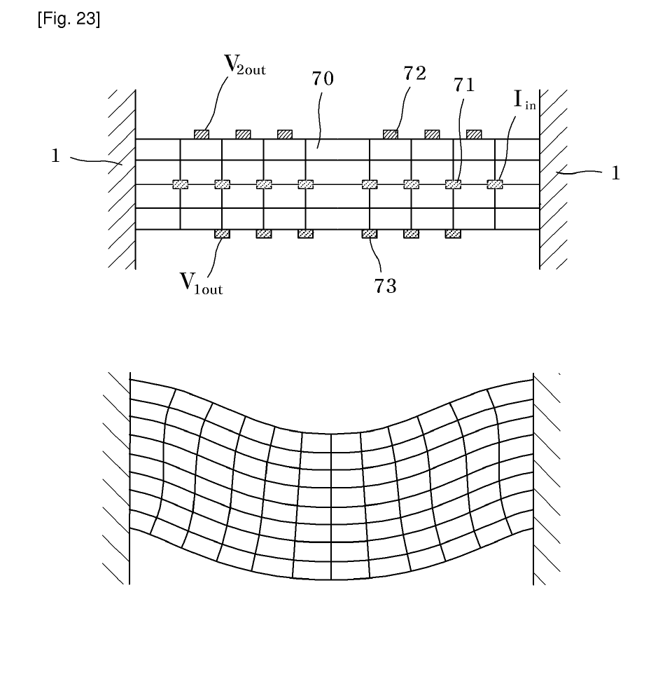

FIGS. 21 and 22 are views showing still another embodiment of a force measuring transducer according to the present invention. The only difference from the embodiments described above is that each of the gauges does not have a zigzag pattern described above.

A deformation-producing unit 61 for producing elastic deformation by a force applied to the surface includes a supporting unit fixed to a fixing unit 1 and a body unit extended from one end of the supporting unit to have a shape of a circle, and the other end of the body unit is fixed to the fixing unit 1. At least either side of the deformation-producing unit 61 is surface-treated so that a force may be generated, and the deformation-producing unit is provided with an input gauge. The input gauge is formed in a shape the same as that of the deformation-producing unit 61, and if the input gauge is formed of an elastically deformable material, the input gauge may substitute for the deformation-producing unit 61.

A first member 62 is provided inside the deformation-producing unit 61 and includes a supporting unit fixed to the fixing unit 1 and a body unit extended from one end of the supporting unit to have a shape of a circle, and the other end of the body unit is fixed to the fixing unit 1.

A second member 63 is provided outside the deformation-producing unit 61 and includes a supporting unit fixed to the fixing unit 1 and a body unit extended from one end of the supporting unit to have a shape of a circle, and the other end of the body unit is fixed to the fixing unit 1.

A first output gauge and a second output gauge are formed in a shape the same as that of the first member 62 and the second member 63, and if the output gauges are formed of an elastically deformable material, the first output gauge and the second output gauge may substitute for the first member 62 and the second member 63.

FIG. 21 is a view showing a force measuring transducer before molecules are adhered to the deformation-producing unit 61, and FIG. 22 is a view showing a force measuring transducer after molecules are adhered to the deformation-producing unit 61. d1 and d2 are provided to be equal before molecules are adhered, whereas d1′ is larger than d2′ after molecules are adhered since the outside diameter is increased by the surface stress of the deformation-producing unit 61. In this case, the distances between the input gauge and the first and second output gauges will be changed, and thus there is a difference between the induced output voltages. It is possible to measure magnitude of a force applied to the surface of the deformation-producing unit 61 using a ratio between the output voltages.

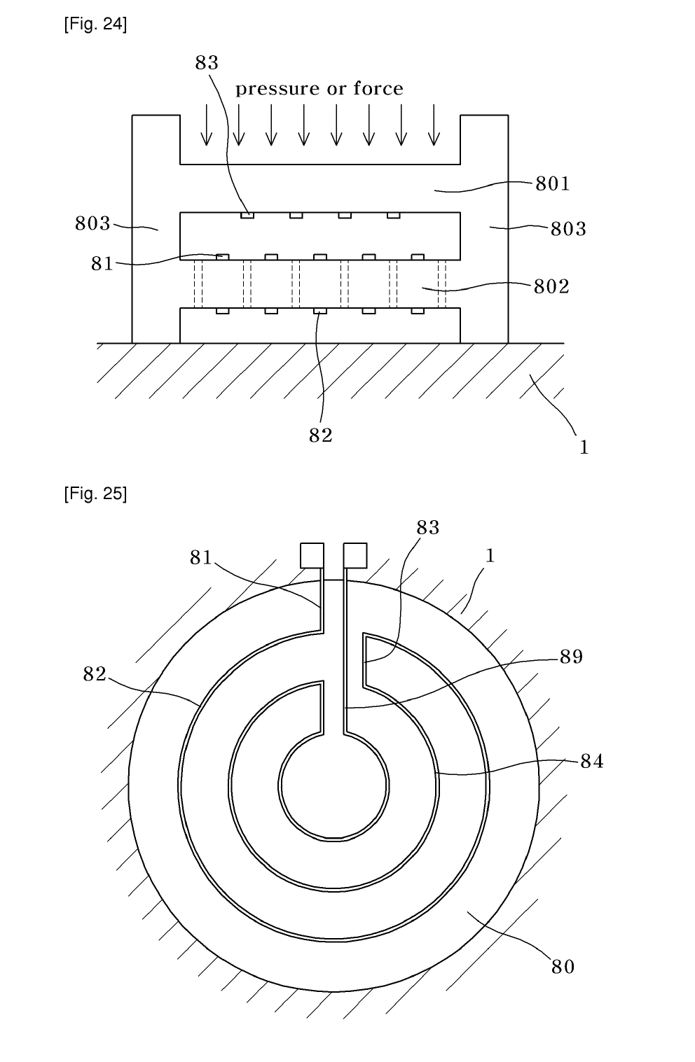

FIGS. 23 and 24 are views showing still another embodiment of a force measuring transducer according to the present invention. The transducer is capable of measuring all kinds of forces according to the present invention, and the figures show an applicable embodiment that is preferable to measuring a mechanical force or pressure. FIG. 23 is a cross-sectional view showing the transducer of the present invention shown from the side before and after deformation. The upper figure of FIG. 23 shows virtual straight lines drawn in the deformation-producing unit 70 before deformation. The lower figure shows the virtual straight lines changed after deformation. It is understood that the virtual straight lines almost do not change in the middle, but deformation is produced severely toward both ends. In addition, the top surface is deformed toward inside, and the bottom surface is deformed toward outside.

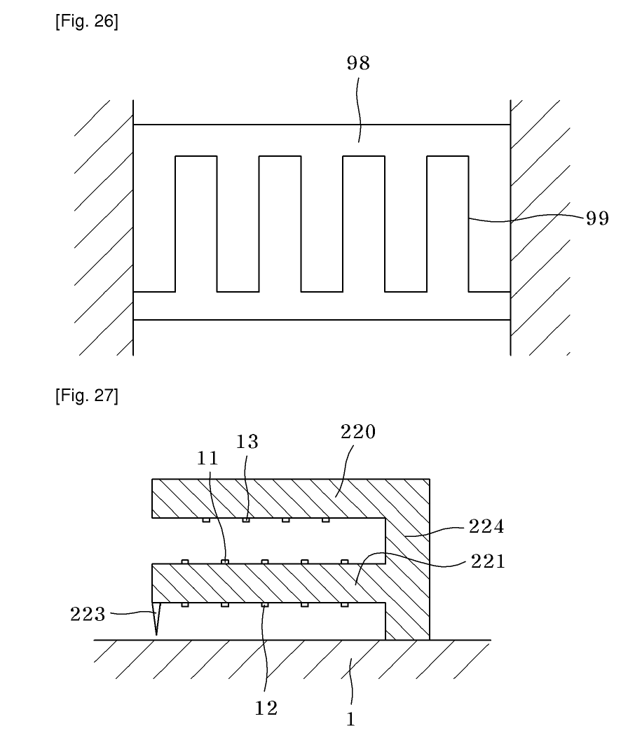

The deformation-producing unit 70 is formed in a shape of a circular or rectangular plate where a force is applied to one surface, and elastic deformation is produced by the force applied to the surface. FIG. 25 is a plan view showing a deformation-producing unit having a shape of a circular plate, and FIG. 26 is a plan view showing a deformation-producing unit having a shape of a rectangular plate.

In FIG. 23, an input gauge 71 having a pattern is provide inside the deformation-producing unit, and a first output gauge 73 and a second output gauge 72 are provided on both sides of the deformation-producing unit. The input gauge 71 is preferably provided in the middle between the first output gauge 73 and the second output gauge 72. The first output gauge 73 and the second output gauge 72 are preferably formed by repeating an electric wire pattern having a pitch the same as that of the input gauge as many as a predetermined number of times with the intervention of the input gauge therebetween. One side of the deformation-producing unit 70 is preferably fixed to the fixing unit 1. Although the input gauge is overlapped with the first output gauge in the figure, it is possible that the input gauge is overlapped with the second output gauge and is provided to be displaced from the first output gauge by ¼ pitch.

FIG. 24 is a view showing another embodiment of the present invention, in which a force or a pressure is measured. A second output gauge 83 having a pattern is provided on the bottom surface of the deformation-producing unit. An input gauge 81 is provided on the top surface of a fixing member that is parallel to the deformation-producing unit, and a first output gauge 82 is provided on the bottom surface thereof. Particularly, the deformation-producing unit and the fixing member are provided in a shape of a circular or rectangular plate, and a space formed by the deformation-producing unit and the fixing member is connected to the outside through fine holes provided in the fixing member. If a force or a pressure is applied to the deformation-producing unit, the gas filled between the deformation-producing unit and the fixing member goes out to outside through the fine holes, and thus deformation of the deformation-producing unit is accomplished. The input gauge 81 is preferably provided in the middle between the first output gauge 82 and the second output gauge 83. The first output gauge 82 and the second output gauge 83 are preferably formed by repeating an electric wire pattern having a pitch the same as that of the input gauge as many as a predetermined number of times with the intervention of the input gauge therebetween. The sides of the deformation-producing unit 801 and the fixing member 802 are preferably fixed to the fixing unit 1.

The positions of the input gauge and the output gauges may be changed. That is, it is possible to provide the first output gauge having a pattern on the top surface of the deformation-producing unit, the input gauge having a pattern on the bottom surface of the deformation-producing unit, and the second output gauge on the top surface of the fixing member provided to be parallel to the deformation-producing unit. Since this can be clearly understood with reference to FIG. 24, it is not shown in the figure.

FIG. 25 is a plan view showing the deformation-producing unit and the fixing member of FIGS. 23 and 24 formed in a shape of a circular plate, and FIG. 26 is a plan view showing the deformation-producing unit and the fixing member of FIGS. 23 and 24 formed in a shape of a rectangular plate. In the case of the circular plate shape of FIG. 25, the gauge pattern includes a first section 85 extended straight, a second section 86 extended from one end of the first section in a shape of a circle, a third section 87 extended straight in a direction the same as that of the first section, and a fourth section 88 extended in a direction opposite to that of the second section in a shape of a circle. It is preferable that the second section of the first output gauge pattern is provided to be overlapped with the second section of the input gauge pattern, and the second section of the second output gauge pattern is provided to be displaced from the second section of the input gauge pattern by ¼ pitch.

FIG. 26 shows the deformation-producing unit and the fixing member provided in a zigzag pattern.

When a force or a pressure is applied to one surface of the deformation-producing unit 70, the deformation-producing unit is deformed like the lower figure shown in FIG. 23. As described in FIG. 9, since relative positions of the first output gauge 72 and the second output gauge 73 are changed with respect to the position of the input gauge 71, an amount of displacement is calculated using a ratio between two output voltages, and magnitude of the applied pressure can be measured through the displacement.

FIG. 22 is a view showing still another embodiment of the present invention, in which a probing tip cantilever of an atomic microscope is applied. A structure of two cantilevers, i.e., upper and lower cantilevers, is included in this embodiment. A probing tip 233 may be provided at an end of the upper cantilever or at an end of the lower cantilever. When the probing tip is provided at an end of the upper cantilever, the upper cantilever is preferably formed to be longer than the lower cantilever. If the cantilever provided with the probing tip is deformed by a force acted upon the probing tip, magnitude of the acted force is measured from the relation between the input gauge and the output gauges. Since the operating principle is the same as described above, details thereof will be omitted. Although it is preferable to provide the input gauge at the cantilever where the probing tip is provided and to provide the output gauges at each of the cantilevers, it is not limited thereto.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A force measuring transducer for measuring a force applied to a surface, the force measuring transducer comprising:
a deformation-producing unit formed in a shape of a cantilever, in which at least one surface is surface-treated to generate a surface force so that elastic deformation may be produced by the force applied to the surface;
an input gauge provided inside the deformation-producing unit and formed by repeating an electric wire pattern having a predetermined pitch as many as a predetermined number of times, in which AC current is applied to both ends; and
a first output gauge and a second output gauge provided at the deformation-producing unit with intervention of the input gauge therebetween and formed by repeating an electric wire pattern having a pitch the same as that of the input gauge as many as a predetermined number of times, wherein
each of the input gauge pattern, the first output gauge pattern and the second output gauge pattern includes a first section extended straight, a second section extended to be perpendicular to the first section, a third section extended to be perpendicular to the second section and parallel to the first section and a pattern connecting section extended to be perpendicular to the third section, wherein
the first section of the first output gauge pattern is provided to be overlapped with the first section of the input gauge pattern, and the first section of the second output gauge pattern is provided to be displaced from the first section of the input gauge pattern by ¼ pitch.

2. The transducer according to claim 1, wherein a surface provided with the first output gauge and the second output gauge in the deformation-producing unit is formed as a concave-convex unit.

3. The transducer according to claim 1, wherein the deformation-producing unit includes a supporting unit fixed to a fixing unit and a body unit extended from an end of the supporting unit to have a shape of a circle.

4. The transducer according to claim 1, wherein the deformation-producing unit includes a supporting unit fixed to a fixing unit and a body unit extended from an end of the supporting unit to have a shape of a spiral.

5. A force measuring transducer for measuring a force applied to a surface, the force measuring transducer comprising:
a deformation-producing unit including a supporting unit fixed to a fixing unit and a body unit extended from an end of the supporting unit to have a shape of a circle, in which the other end of the body unit is a free end, and at least one surface is surface-treated to generate a surface force so that elastic deformation may be produced by the force applied to the surface;
an input gauge provided at the deformation-producing unit and formed by repeating an electric wire pattern having a predetermined pitch as many as a predetermined number of times, in which AC current is applied to both ends;
a first member provided inside the deformation-producing unit and including a supporting unit fixed to the fixing unit and a body unit extended from an end of the supporting unit to have a shape of a circle, in which the other end of the body unit is fixed to the fixing unit;
a second member provided outside the deformation-producing unit and including a supporting unit fixed to the fixing unit and a body unit extended from an end of the supporting unit to have a shape of a circle, in which the other end of the body unit is fixed to the fixing unit;
a first output gauge and a second output gauge provided at the first member and the second member with intervention of the input gauge therebetween and formed by repeating an electric wire pattern having a pitch the same as that of the input gauge as many as a predetermined number of times, wherein
each of the input gauge pattern, the first output gauge pattern and the second output gauge pattern includes a first section extended straight, a second section extended to be perpendicular to the first section, a third section extended to be perpendicular to the second section and parallel to the first section and a pattern connecting section extended to be perpendicular to the third section, wherein
the first section of the first output gauge pattern is provided to be overlapped with the first section of the input gauge pattern, and the first section of the second output gauge pattern is provided to be displaced from the first section of the input gauge pattern by ¼ pitch.

6. A force measuring transducer for measuring a force applied to a surface, the force measuring transducer comprising:
a deformation-producing unit including a supporting unit fixed to a fixing unit and a body unit extended from an end of the supporting unit to have a shape of a spiral, in which the other end of the body unit is a free end, and at least one surface is surface-treated to generate a surface force so that elastic deformation may be produced by the force applied to the surface;
an input gauge provided at the deformation-producing unit and formed by repeating an electric wire pattern having a predetermined pitch as many as a predetermined number of times, in which AC current is applied to both ends;
a first member provided inside the deformation-producing unit and including a supporting unit fixed to the fixing unit and a body unit extended from an end of the supporting unit to have a shape of a spiral, in which the other end of the body unit is fixed to the fixing unit;
a second member provided outside the deformation-producing unit and including a supporting unit fixed to the fixing unit and a body unit extended from an end of the supporting unit to have a shape of a spiral, in which the other end of the body unit is fixed to the fixing unit;
a first output gauge and a second output gauge provided at the first member and the second member with intervention of the input gauge therebetween and formed by repeating an electric wire pattern having a pitch the same as that of the input gauge as many as a predetermined number of times, wherein
each of the input gauge pattern, the first output gauge pattern and the second output gauge pattern includes a first section extended straight, a second section extended to be perpendicular to the first section, a third section extended to be perpendicular to the second section and parallel to the first section and a pattern connecting section extended to be perpendicular to the third section, wherein
the first section of the first output gauge pattern is provided to be overlapped with the first section of the input gauge pattern, and the first section of the second output gauge pattern is provided to be displaced from the first section of the input gauge pattern by ¼ pitch.

7. The transducer according to claim 5, wherein the other end of the body unit in the deformation-producing unit is fixed to the fixing unit.

8. A force measuring transducer for measuring a force applied to a surface, the force measuring transducer comprising:
a deformation-producing unit having an outer surface formed in a shape of a circular plate fixed to a fixing unit, in which elastic deformation is produced by the force applied to the surface;
an input gauge provided inside the deformation-producing unit and formed by repeating an electric wire pattern having a predetermined pitch as many as a predetermined number of times, in which AC current is applied to both ends; and
a first output gauge and a second output gauge provided at the deformation-producing unit with intervention of the input gauge therebetween and formed by repeating an electric wire pattern having a pitch the same as that of the input gauge as many as a predetermined number of times, wherein
each of the input gauge pattern, the first output gauge pattern and the second output gauge pattern includes a first section extended straight, a second section extended from an end of the first section in a shape of a circle, a third section extended straight in a direction the same as that of the first section and a fourth section extended in a direction opposite to that of the second section in a shape of a circle, wherein
the second section of the first output gauge pattern is provided to be overlapped with the second section of the input gauge pattern, and the second section of the second output gauge pattern is provided to be displaced from the second section of the input gauge pattern by ¼ pitch.

9. A force measuring transducer for measuring a force applied to a surface, the force measuring transducer comprising:
a deformation-producing unit having an outer surface formed in a shape of a circular plate fixed to a fixing unit, in which elastic deformation is produced by the force applied to the surface;
a fixing member having an outer surface formed in a shape of a circular plate fixed to the fixing unit, provided to be parallel to the deformation-producing unit, and provided with at least one or more penetrating holes;
an input gauge provided at the fixing member and formed by repeating an electric wire pattern having a predetermined pitch as many as a predetermined number of times, in which AC current is applied to both ends; and
a first output gauge and a second output gauge provided at the fixing member and the deformation-producing unit with intervention of the input gauge therebetween and formed by repeating an electric wire pattern having a pitch the same as that of the input gauge as many as a predetermined number of times, wherein
each of the input gauge pattern, the first output gauge pattern and the second output gauge pattern includes a first section extended straight, a second section extended from an end of the first section in a shape of a circle, a third section extended straight in a direction the same as that of the first section and a fourth section extended in a direction opposite to that of the second section in a shape of a circle, wherein
the second section of the first output gauge pattern is provided to be overlapped with the second section of the input gauge pattern, and the second section of the second output gauge pattern is provided to be displaced from the second section of the input gauge pattern by ¼ pitch.

10. The transducer according to claim 8, wherein a shape of the deformation-producing unit is a shape of a rectangular plate.

11. A force measuring transducer for measuring a force applied to a surface, the force measuring transducer comprising:
a deformation-producing unit including a supporting unit fixed to a fixing unit and a body unit extended from an end of the supporting unit to have a shape of a circle, in which the other end of the body unit is fixed to the fixing unit, and at least one surface is surface-treated to generate a surface force so that elastic deformation may be produced by the force applied to the surface;
an input gauge provided at the deformation-producing unit, in which AC current is applied to both ends;
a first member provided inside the deformation-producing unit and including a supporting unit fixed to the fixing unit and a body unit extended from an end of the supporting unit to have a shape of a circle, in which the other end of the body unit is fixed to the fixing unit;
a second member provided outside the deformation-producing unit and including a supporting unit fixed to the fixing unit and a body unit extended from an end of the supporting unit to have a shape of a circle, in which the other end of the body unit is fixed to the fixing unit; and
a first output gauge and a second output gauge provided at the first member and the second member.

12. A force measuring transducer for measuring a force applied to a surface, the force measuring transducer comprising:
a deformation-producing unit formed in a shape of a cantilever, in which at least one surface is surface-treated to generate a surface force so that elastic deformation may be produced by the force applied to the surface;
a fixing member provided to be parallel to the deformation-producing unit;
an input gauge provided at the deformation-producing unit and formed by repeating an electric wire pattern having a predetermined pitch as many as a predetermined number of times, in which AC current is applied to both ends; and
a first output gauge and a second output gauge provided at the deformation-producing unit and the fixing member with intervention of the input gauge therebetween and formed by repeating an electric wire pattern having a pitch the same as that of the input gauge as many as a predetermined number of times, wherein
each of the input gauge pattern, the first output gauge pattern and the second output gauge pattern includes a first section extended straight, a second section extended to be perpendicular to the first section, a third section extended to be perpendicular to the second section and parallel to the first section and a pattern connecting section extended to be perpendicular to the third section, wherein
the first section of the first output gauge pattern is provided to be overlapped with the first section of the input gauge pattern, and the first section of the second output gauge pattern is provided to be displaced from the first section of the input gauge pattern by ¼ pitch.

13. A force measuring transducer for measuring a force applied to a surface, the force measuring transducer comprising:
a deformation-producing unit formed in a shape of a cantilever, in which at least one surface is surface-treated to generate a surface force so that elastic deformation may be produced by the force applied to the surface;
a fixing member provided to be parallel to the deformation-producing unit;
an input gauge provided at the fixing member and formed by repeating an electric wire pattern having a predetermined pitch as many as a predetermined number of times, in which AC current is applied to both ends; and
a first output gauge and a second output gauge provided at the fixing member and the deformation-producing unit with intervention of the input gauge therebetween and formed by repeating an electric wire pattern having a pitch the same as that of the input gauge as many as a predetermined number of times, wherein
each of the input gauge pattern, the first output gauge pattern and the second output gauge pattern includes a first section extended straight, a second section extended to be perpendicular to the first section, a third section extended to be perpendicular to the second section and parallel to the first section and a pattern connecting section extended to be perpendicular to the third section, wherein
the first section of the first output gauge pattern is provided to be overlapped with the first section of the input gauge pattern, and the first section of the second output gauge pattern is provided to be displaced from the first section of the input gauge pattern by ¼ pitch.

14. The transducer according to claim 12, wherein the deformation-producing unit includes a supporting unit fixed to a fixing unit and a body unit extended from an end of the supporting unit to have a shape of a circle, and the fixing member is provided in a shape of a circular plate having a concentric circle in parallel to the deformation-producing unit.

15. A force measuring transducer for measuring a force applied to a surface, the force measuring transducer comprising:
a deformation-producing unit including no surface-treatment for generating a surface force and formed in a shape being provided with a probing tip at an end thereof, in which elastic deformation is produced by a force applied to the probing tip;
a fixing member provided to be parallel to the deformation-producing unit;
an input gauge provided at the deformation-producing unit and formed by repeating an electric wire pattern having a predetermined pitch as many as a predetermined number of times, in which AC current is applied to both ends; and
a first output gauge and a second output gauge provided at the deformation-producing unit and the fixing member with intervention of the input gauge therebetween and formed by repeating an electric wire pattern having a pitch the same as that of the input gauge as many as a predetermined number of times, wherein
each of the input gauge pattern, the first output gauge pattern and the second output gauge pattern includes a first section extended straight, a second section extended to be perpendicular to the first section, a third section extended to be perpendicular to the second section and parallel to the first section and a pattern connecting section extended to be perpendicular to the third section, wherein
the first section of the first output gauge pattern is provided to be overlapped with the first section of the input gauge pattern, and the first section of the second output gauge pattern is provided to be displaced from the first section of the input gauge pattern by ¼ pitch.

16. The transducer according to claim 1, wherein the first output gauge pattern is provided to be displaced from the input gauge pattern by ¼ pitch and the second output gauge pattern is provided to be overlapped with the input gauge pattern.

17. The transducer according to claim 1, wherein the applied force is measured through a ratio between magnitude of induction voltage measured by the first output gauge and magnitude of induction voltage measured by the second output gauge.

18. The transducer according to claim 6, wherein the other end of the body unit in the deformation-producing unit is fixed to the fixing unit.

19. The transducer according to claim 9, wherein a shape of the deformation-producing unit is a shape of a rectangular plate.
